(19) United States
(12) Patent Application Publication
(10) Pub. No.: US 2026/0098768 A1
(43) Pub. Date: Apr. 9, 2026

(54) RESISTIVE STRAIN SENSOR UNIT AND MOTION RECOGNITION GUARD USING THE SAME

(71) Applicant: WAVE COMPANY CO., LTD., Seoul (KR)

(72) Inventors: Na-Yun CHO, Seoul (KR); Sang-Chul LEE, Seoul (KR); Ji-Hun HAN, Seoul (KR)

(21) Appl. No.: 18/987,793

(22) Filed: Dec. 19, 2024

(30) Foreign Application Priority Data
Oct. 4, 2024 (KR) 10-2024-0134764

(51) Int. Cl. G01L 1/22

(52) U.S. Cl. CPC G01L 1/2293

(57) ABSTRACT

Disclosed is a resistive strain sensor unit that is capable of reliably recognizing joint bending of a human body. The resistive strain sensor unit includes a resistive strain sensor pattern provided by screen printing and curing liquid electrical conductive silicone rubber on a fabric, an electrical terminal disposed on each of both ends of the resistive strain sensor pattern, and a stretching reduction member disposed on the fabric adjacent to the resistive strain sensor pattern in a direction in which the resistive strain sensor pattern is stretched.

### REFERENCE TO RELATED APPLICATIONS

This application claims the priority benefit of Korean Patent Application No. 10-2024-0134764 filed on Oct. 4, 2024, the entire contents of which are incorporated herein by reference.

### FIELD OF THE INVENTION

The present invention relates to a resistive strain sensor unit, and more particularly, to a resistive strain sensor unit capable of reliably recognizing joint bending of a human body and a motion recognition guard using the same.

### BACKGROUND OF THE INVENTION

Motion recognition technologies for recognizing three-dimensional movements of machines or users in a space has recently been developing rapidly along with the development of sensor technologies, and has created various derivative technologies and products.

Motion recognition is a technology that recognizes a direction of movement, a speed, acceleration, etc. of a device moving in a space. Various motion recognition technologies have been developed, but recently, researches on motion recognition devices provided with sensors that are capable of recognizing their own motions are actively being conducted.

Since the motion recognition devices do not require external equipment, there are no spatial constraints, and the motion recognition device are manufactured in small sizes, and thus, the motion recognition devices are being adopted as mobile devices and are also being applied to various wearable devices.

Sensors commonly used in the motion recognition devices include geomagnetic sensors that recognize changes in Earth's magnetic fields around multiple axes, sensors that measure acceleration and/or angular velocity according to movement, or gyro sensors that output three angular velocity measurements based on three mutually orthogonal axes.

Each of the gyro sensors and the acceleration sensors may exhibit errors in different movement situations. Thus, both the gyro sensor and the acceleration sensor may be used together to compensate for each other, and the geomagnetic sensors and the temperature sensors may also be used to compensate for the mistakes and errors of the gyro sensor.

However, the sensors have disadvantages of being expensive and complex to be processed, although the more sensors are used, the more accurate the motion may be recognized.

For example, in the case of IMU sensors, which are inertial measurement units, there is a disadvantage in that the IMU sensors are expensive because two or more sensors are required for recognizing reliable joint bending in various situations.

In addition, there is a capacitive strain sensor, which has an advantage of measuring more precisely than the resistive strain sensor, but has a disadvantage of having a complex sensor structure, being expensive, and being complex because an AC voltage has be applied to the sensor to read a capacitance value.

### SUMMARY OF THE INVENTION

An object of the present invention is to provide a resistive strain sensor unit that is capable of reliably recognizing joint bending of a human body.

Another object of the present invention is to provide a guard provided with a controller having a simple circuit.

A further another object of the present invention is to provide a guard that is capable of reliably measuring join bending information of a human body.

According to an aspect of the present invention, there is provided a resistive strain sensor unit including: a fabric; a resistive strain sensor pattern provided by screen printing and curing liquid electrical conductive silicone rubber on the fabric; an electrical terminal disposed on each of both ends of the resistive strain sensor pattern; and a stretching reduction member disposed on the fabric adjacent to the resistive strain sensor pattern in a direction in which the resistive strain sensor pattern is stretched to reduce stretching of the resistive strain sensor pattern.

An end portion of the stretching reduction member, which is adjacent to the resistive strain sensor pattern, may overlap the resistive strain sensor pattern.

The stretching reduction member may be a cotton blend fabric or a non-stretchable film and be bonded to be thermally compressed to the fabric by hot melt.

The liquid electrical conductive silicone rubber may include carbon black and selectively include carbon fibers.

As the resistive strain sensor pattern is stretched, electrical resistance may be changed.

The resistive strain sensor pattern may have U or V shape.

An electrically conductive rubber pad may be interposed between the electrical terminal and the resistive strain sensor pattern.

According to another aspect of the present invention, there is provided a motion recognition guard including: a body worn on a joint portion of a human body and provided as a fabric; the resistive strain sensor unit of claim 1, which is installed on the body; and a controller electrically connected to an electrical terminal of the resistive strain sensor unit.

The controller may be provided with an MCU to measure a change in DC voltage output from a battery according to a change in resistance of the resistive strain sensor pattern through the MCU, thereby generating a bending count.

The controller may be provided with a Bluetooth module and be configured to wirelessly transmit the bending count generated by the MCU to a remote device through the Bluetooth module.

### BRIEF DESCRIPTION OF THE DRAWINGS

The above objects and other advantages of the present invention will become more apparent by describing in detail exemplary embodiments thereof with reference to the attached drawings in which:

FIG. 1 is a view illustrating a state in which a guard is applied according to the present invention;

FIG. 2 is a view illustrating a resistive strain sensor unit;

FIG. 3 is a view of a guard to which the resistive strain sensor unit is applied; and

FIG. 4 is a view illustrating another example of the guard to which the resistive strain sensor unit is applied.

### DETAILED DESCRIPTION OF THE INVENTION

It should be noted that technical terms used in the present invention are only used to describe particular embodiments and are not intended to limit the present invention. In addition, the technical terms used in the present invention should be interpreted as having a meaning generally understood by a person of ordinary skill in the technical field to which the present invention belongs, unless specifically defined to have a different meaning in the present invention, and should not be interpreted in an overly comprehensive meaning or an overly narrow meaning.

Hereinafter, specific embodiments will be described in detail with reference to the accompanying drawings.

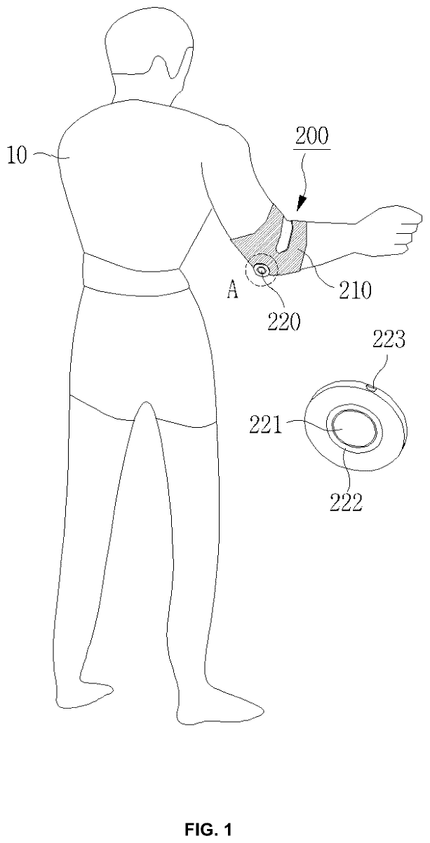

FIG. 1 is a view illustrating a state in which a guard is applied according to the present invention.

In FIG. 1, a user 10 is shown wearing a guard 200 on an elbow, but it is not limited thereto, and may be applied to all joint portions of a human body.

In addition, the guard 200 may have a structure attached to the joint portion or a sleeve structure inserted into the joint portion.

The guard 200 may be constituted by a body 210 and a controller 220 that is detachably coupled to the body 210 and electrically connected.

The guard 200 according to this embodiment may provide exercise information, for example, by being linked with a mobile phone. In other words, information about the number of times of bending may be transmitted to the mobile phone whenever a joint portion on which the guard 200 is installed is bent to assist user's exercise.

The controller 220 may be provided with a power button 221 and an indicator LED 222 on a front surface thereof and also may be provided with an electrical terminal on a rear surface and be physically and electrically connected to an electrical terminal of the guard 200, which is described later. Here, an USB terminal 223 for charging a battery may be exposed to a side surface of the controller 220.

In addition, the controller 220 may be provided with an MCU therein to measure a change in DC voltage supplied from the battery due to a change in resistance of the resistive strain sensor pattern through an ADC circuit built in the MCU and also may be provided with a Bluetooth module to wirelessly transmit a bending count together with an ID to the mobile phone.

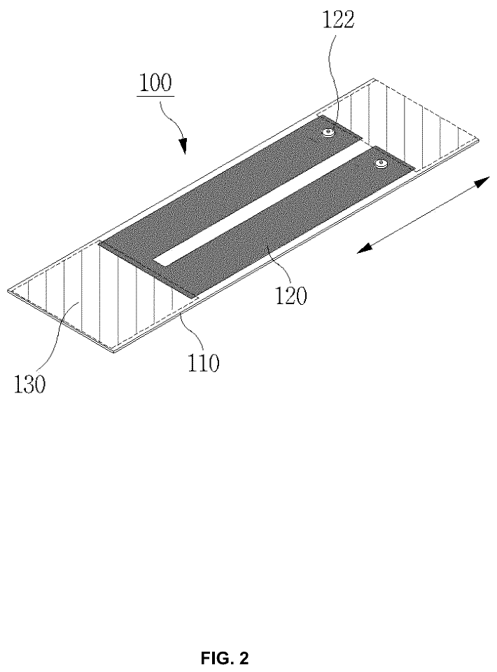

FIG. 2 is a view illustrating the resistive strain sensor unit.

The resistive strain sensor unit 100 is constituted by a fabric 110, a resistive strain sensor pattern 120 provided by screen printing and curing liquid electrical conductive silicone rubber on the fabric 110, an electrical terminal 122 disposed on each of both ends of the resistive strain sensor pattern 120, and a stretching reduction member 130 disposed on the fabric 110 adjacent to the resistive strain sensor pattern 120 in a direction in which the resistive strain sensor pattern 120 is stretched.

The stretching reduction member 130 literally means a material that is capable of reducing stretching of other materials, and in this embodiment, means a material that is capable of reducing stretching of the resistive strain sensor pattern 120.

As the stretching reduction member 130, for example, a non-stretchable film that is not stretched may be applied.

An end portion of the stretching reduction member 130, which is adjacent to the resistive strain sensor pattern 120, may overlap the resistive strain sensor pattern 120.

The fabric 110 may be a single-piece fabric or a combined fabric, and in the case of the combined fabric, sensitivity of the resistive strain sensor pattern 120 may increase.

As for the fabric 110, a blended fabric composed of, for example, a polyurethane thread (spandex) and a polyester thread may be mainly used, and a nylon thread may be included instead of the polyester thread.

The liquid electrical conductive silicone rubber for forming the resistive strain sensor pattern 120 may contain carbon black and optionally contain carbon fibers to reduce overall electrical resistance of the resistive strain sensor pattern 120 and slightly increase in sensitivity.

The resistive strain sensor pattern 120 may be provided in a U or V shape, and electrical terminals 122 may be disposed on each end thereof.

Due to this configuration, the resistive strain sensor pattern may be provided in two layers although having a short length to obtain a sufficient measurement value for identifying the bending. In addition, a distance between both the ends of the resistive strain sensor pattern may be constant, and since the distance between both the ends is short, a size of the controller 220 may be small.

The resistive strain sensor pattern 120 may be stretched in a direction indicated by an arrow in FIG. 2 as the joint portion is bent, and in this process, the electrical resistance of the resistive strain sensor pattern 120 may be changed.

Thus, a width of the resistive strain sensor pattern 120 may be wide so that the resistive strain sensor pattern 120 is sufficiently stretched even if the user's joint portion is not precisely disposed on the resistive strain sensor pattern 120.

The stretching reduction member 130 may be made of, for example, a cotton blend fabric, but has much lower stretching than the resistive strain sensor pattern 120.

As described above, the stretching reduction member 130 may be bonded to the fabric 110 by thermal compression, for example, using hot melt, so as to be adjacent to the resistive strain sensor pattern 120 in the direction in which the resistive strain sensor pattern 120 is stretched.

According to this structure, when it is assumed that the fabric 110 is stretched to the same length due to external force applied to the fabric 10, since the stretching reduction member 130 is not well stretched, the resistive strain sensor pattern 120 may be relatively more stretched.

As a result, the sufficient measurement value may be obtained to identify the bending of the guard to which the fabric is applied.

Instead of the stretching reduction member 130 according to this embodiment, a non-stretchable layer may be provided by applying and curing a liquid composition having non-stretchable properties.

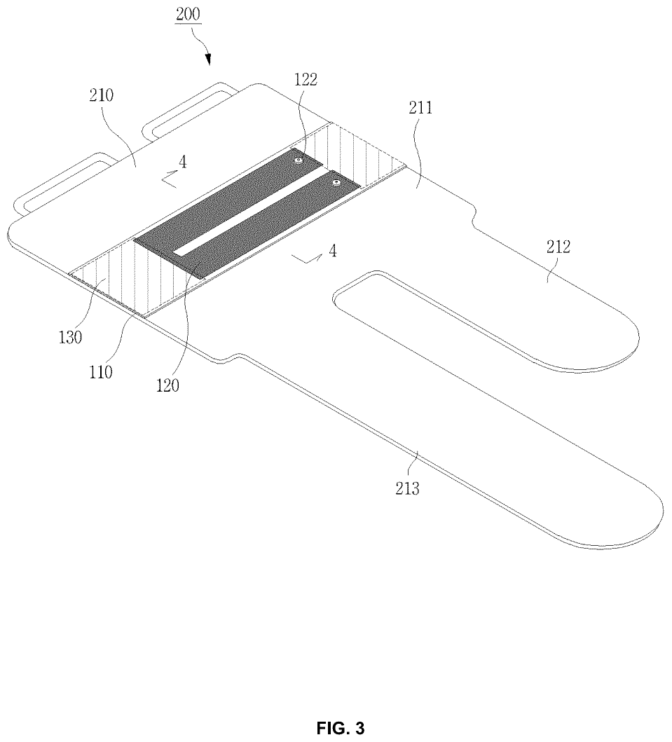

FIG. 3 is a view of the guard to which the resistive strain sensor unit is applied. Particularly, FIG. 3 illustrates a state when a rear surface of the guard is viewed from above.

A guard 200 according to the present invention may be constituted by a body 210 in which a contact part that is in contact with the joint portion and tightening straps 212 and 213 that tighten the contact part 211 wound around the joint portion are integrated with each other, and a resistive strain sensor unit 100 installed on the contact part 211 of the body 210.

Since the guard 200 according to this embodiment is a strap type that is wound around the joint portion to tightens the joint portion, the tightening straps 212 and 213 may be required. However, in the case of a sleeve type that is forcibly fitted into the joint portion, a cylindrical body without the tightening straps 212 and 213 may be provided.

In this embodiment, the resistive strain sensor unit 100 provided with the resistive strain sensor pattern 120 and the stretching reduction member 130 on the separate fabric 110 may be sewn and attached to the body 210 of the guard. However, this embodiment is not limited thereto, and the resistive strain sensor pattern 120 may be directly disposed on the body 210 of the guard, and the stretching reduction member 130 may be in direct contact with the body 210 of the guard.

In addition, in this embodiment, for convenience of explanation, the resistive strain sensor unit 100 is described as being exposed to the outside, but the resistive strain sensor unit 100 may be covered by a separate protective fabric so as not to be exposed. In this case, the electrical terminal 122 may be exposed to the outside of the protective fabric.

A snap button or a magnetic button may be typically used as the electrical terminal 122, and an electrically conductive rubber pad may be interposed between the electrical terminal 122 and the resistive strain sensor pattern 120 to ensure stable electrical contact with the resistive strain sensor pattern 120.

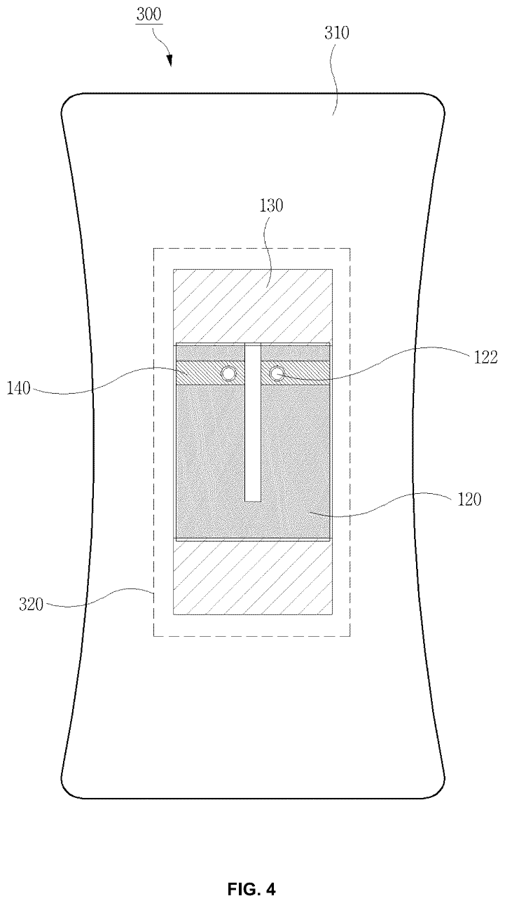

FIG. 4 is a view illustrating another example of the guard to which the resistive strain sensor unit is applied. For convenience of explanation, the inside of the guard may be turned over so as to be exposed to the outside.

A guard 300 according to this embodiment may be a sleeve type and be provided as a cylindrical single body 310, and a resistive strain sensor unit 100 may be installed by sewing on an inner surface of the body 310, and a separate protective fabric 320 may be sewn to cover the resistive strain sensor unit 100 so that the joint portion of the user 10 does not in direct contact with the resistive strain sensor unit 100.

In this embodiment, as described above, the electrically conductive rubber pad 140 may be interposed between the electrical terminal 122 and the resistive strain sensor pattern 120 to ensure the stable electrical contact between the electrical terminal 122 and the resistive strain sensor pattern 120.

Hereinafter, a process in which the user 10 wears the guard 200 to perform burpee exercise will be described as an example.

The controller 220 of each guard 200 may be wirelessly connected and mapped through an exercise application installed in the mobile phone, and an identification ID may be assigned to the controller 220 of each guard 200.

Calibration may be performed for each guard 200 installed on each of a knee and an elbow, and an ADC value measured when the body is maximally bent and unfolded may be stored as a reference value.

When the calibration is completed, and the user starts the burpee exercise, the resistive strain sensor pattern 120 of the resistive strain sensor unit 100 may be stretched by the bending of the joint and then returned to its original state by the unfolding.

The controller 220 of each guard 200 may measure a change in DC voltage output from a battery according to a change in resistance of the resistive strain sensor pattern 120 due to the bending and unfolding of the knee and elbow joints using the ADC circuit built in the MCU.

The controller 220 of each guard 200 may compare the measured resistance change with the stored reference ADC value, and if it is determined as the bending, a bending count may be wirelessly transmitted to the mobile phone together with the identification ID.

The exercise application of the mobile phone may receive and accumulate the bending count and finally calculate the number of times of the bending based on the accumulated count.

According to the present invention, the stretching reduction member and the resistive strain sensor pattern may be applied to reliably recognize the joint bending.

In addition, since the circuit for measuring the resistance change of the resistive strain sensor is simple, the size of the controller constituting the guard may be reduced to improve the reliability.

Although the exemplary embodiment of the present invention has been shown and described above, various changes and modifications which can be understood by a person skilled in the art may also be made. Therefore, the present invention should not be construed as being limited to only the foregoing embodiment, but be construed by the appended claims.

What is claimed is:

1. A resistive strain sensor unit comprising:
a fabric;
a resistive strain sensor pattern provided by screen printing and curing liquid electrical conductive silicone rubber on the fabric;
an electrical terminal disposed on each of both ends of the resistive strain sensor pattern; and
a stretching reduction member disposed on the fabric adjacent to the resistive strain sensor pattern in a direction in which the resistive strain sensor pattern is stretched to reduce stretching of the resistive strain sensor pattern.

2. The resistive strain sensor unit of claim 1, wherein an end portion of the stretching reduction member, which is adjacent to the resistive strain sensor pattern, overlaps the resistive strain sensor pattern.

3. The resistive strain sensor unit of claim 1, wherein the stretching reduction member is a cotton blend fabric or a non-stretchable film and is bonded to be thermally compressed to the fabric by hot melt.

4. The resistive strain sensor unit of claim 1, wherein the liquid electrical conductive silicone rubber comprises carbon black and selectively comprises carbon fibers.

5. The resistive strain sensor unit of claim 1, wherein, as the resistive strain sensor pattern is stretched, electrical resistance is changed.

6. The resistive strain sensor unit of claim 1, wherein the resistive strain sensor pattern has a U or V shape.

7. The resistive strain sensor unit of claim 1, wherein an electrically conductive rubber pad is interposed between the electrical terminal and the resistive strain sensor pattern.

8. A motion recognition guard comprising:
a body worn on a joint portion of a human body and provided as a fabric;
the resistive strain sensor unit of claim 1, which is installed on the body; and
a controller electrically connected to an electrical terminal of the resistive strain sensor unit.

9. The motion recognition guard of claim 8, wherein the controller is provided with an MCU to measure a change in DC voltage output from a battery according to a change in resistance of the resistive strain sensor pattern through the MCU, thereby generating a bending count.

10. The motion recognition guard of claim 9, wherein the controller is provided with a Bluetooth module and is configured to wirelessly transmit the bending count generated by the MCU to a remote device through the Bluetooth module.
